(19) United States
(12) Patent Application Publication
(10) Pub. No.: US 2003/0011636 A1
(43) Pub. Date: Jan. 16, 2003

(54) Method for magnifying images on a display screen and an interactive television guide system implementing the method

(76) Inventors: Gene Feroglia, Los Altos, CA (US); Brian Kohne, San Jose, CA (US); Dan Kikinis, Saratoga, CA (US)

Correspondence Address: John P. Ward, Blakely, Sokoloff, Taylor & Zafman LLP, 12400 Wilshire Boulevard, Seventh Floor, Los Angeles, CA, 90025-1030, US

(21) Appl. No.: 10/171,024

(22) Filed: Jun. 11, 2002

Related U.S. Application Data
(60) Provisional application No. 60/298,483, filed on Jun. 14, 2001.

(51) Int. Cl. G09G 5/00

(52) U.S. Cl. 345/767

(57) ABSTRACT

In one case, the invention provides a method for magnifying content. The method comprises displaying content on a display; displaying a magnifying tool on the display, the magnifying tool comprising a display area; determining an element of the displayed content located at coordinates at the display within the display area; identifying a data component for the element; determining a three-dimensional object having a surface to which the data component is to be mapped; and rendering a magnified image within the display area by mapping the data component to the surface.

### PRIORITY

The present application hereby claims the benefit of the filing date of a related Provisional Application filed on Jun. 14, 2001, and assigned Application Serial No. 60/298,483 and is hereby incorporated by reference.

### FIELD OF THE INVENTION

This invention relates to the displaying of images on a display screen. In particular it relates to techniques for magnifying portions of the displayed images and to an interactive television program guide system implementing the techniques.

### BACKGROUND

Computer, television, or user-interface screens may be used to display digital images, which, in some cases may be highly packed, containing a large amount of text data. In such cases, it is desirable to provide a magnifying tool to enable a user to magnify selected portions of an image so that details obscured because of the large amount of data in the image may be viewed.

Existing magnifying tools known to the inventor make use of a technique wherein selected data is resized to a greater dimension. Thus, for example, if the selected data is represented as a bitmap, resizing involves redrawing or rendering the data so that each pixel in the data is represented by two pixels.

Such magnifying tools are effective when viewing text using a word processor. However, there are certain entertainment environments such as an interactive programming guide-type environment or a television portal-type environment where to simply magnify a selected portion of an image as described above would be to lose an opportunity to make enhancements to the selected portion thereby to render the selected portion visually more appealing or impressive to a viewer.

### BRIEF DESCRIPTION OF THE DRAWINGS

FIG. 1 shows a screen shot of a display of an interactive programming guide implementing a magnification technique in accordance with one case;

FIG. 2 shows another view of the display of FIG. 1;

FIG. 3 illustrates operations performed by an interactive programming guide system in accordance with another case;

FIG. 4 illustrates a mapping technique used in some cases;

FIG. 5 shows a flow chart of operations performed by an interactive program guide system in accordance with another case;

FIG. 6 shows a flow chart of operations performed by an interactive program guide system in accordance with yet another case; and

FIG. 7 shows a high level block diagram of components of an interactive program guide system in accordance with one case.

### DETAILED DESCRIPTION

In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in this specification to “one case” or “a case” means that a particular feature, structure, or characteristic described in connection with the case is included in at least one case of the invention. The appearances of the phrase “in one case” in various places in the specification are not necessarily all referring to the same case, nor are separate or alternative cases mutually exclusive of other cases. Moreover, various features are described which may be exhibited by some cases and not by others. Similarly, various requirements are described which may be requirements for some cases but not other cases.

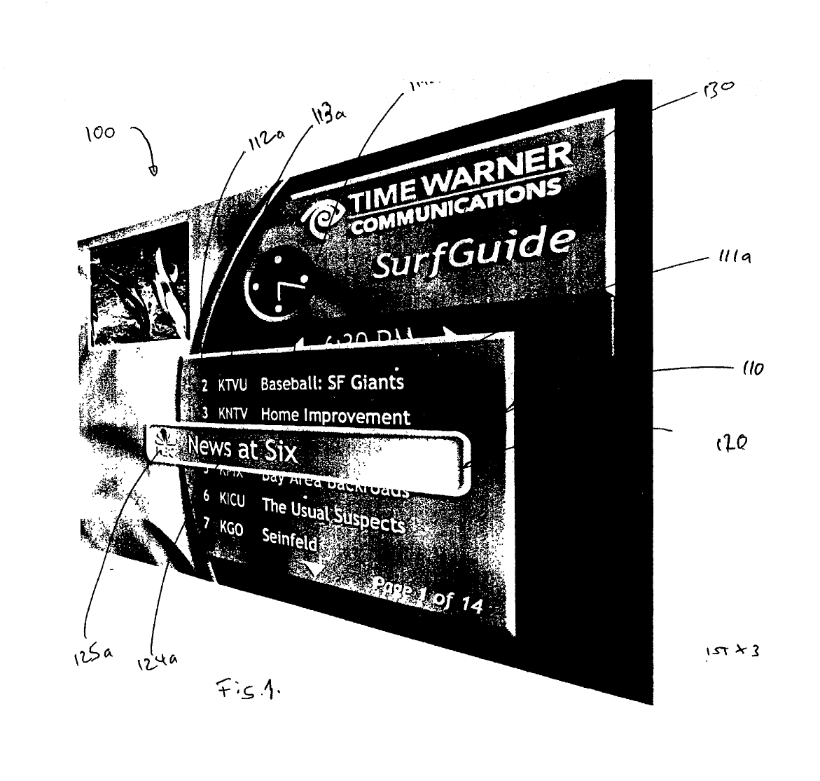

FIG. 1 shows a three-dimensional (3-D) perspective view of display in the form of a screen 100, which is built out of 3-D elements. Elements within screen 100 include, in addition to the live video image in the upper left corner (no number), branding section 130 which shows, for purposes of this example only, a Time-Warner Communications brand (all trademarks belong to their respective owners); and the area of interest 110 (in this example, a program selection panel), which is suspended in space in front of the main plane of the screen 100.

Area 110 contains, in this example, a listed series of elements 111a-n. Each of these elements 111a-n contains, in this example, a channel number 112(a-n), station indicator 113(a-n), and program description 114(a-n). In the first line 111a, channel number 112a is 2. Station call letters 113a are KTVU, and the program description 114a is “Baseball: SF Giants.”

A magnifying tool comprising a magnifying or display area 120 is suspended in front of area 110. Instead of a sized-up image as taught in the prior art, display area 120 contains images of the data in elements 112c, 113, and 114c in a “transformed” magnified image that contains, for example, an image 125 of a network logo in place of the alphanumeric channel number and station call letters. In this example, the channel number and call letters would be 4 and KRON, respectively. In addition, magnifying area 120 contains a description 124a (in this example, “News at Six”) that is possibly different or simplified from the unmagnified description from which it is generated. Because each object has its own behavior, the magnifying tool may choose to display network logos and abbreviated titles only. Naturally, other items may be added, omitted or simplified, or otherwise modified rather than just magnified (for example, a different font may be used, or a different color).

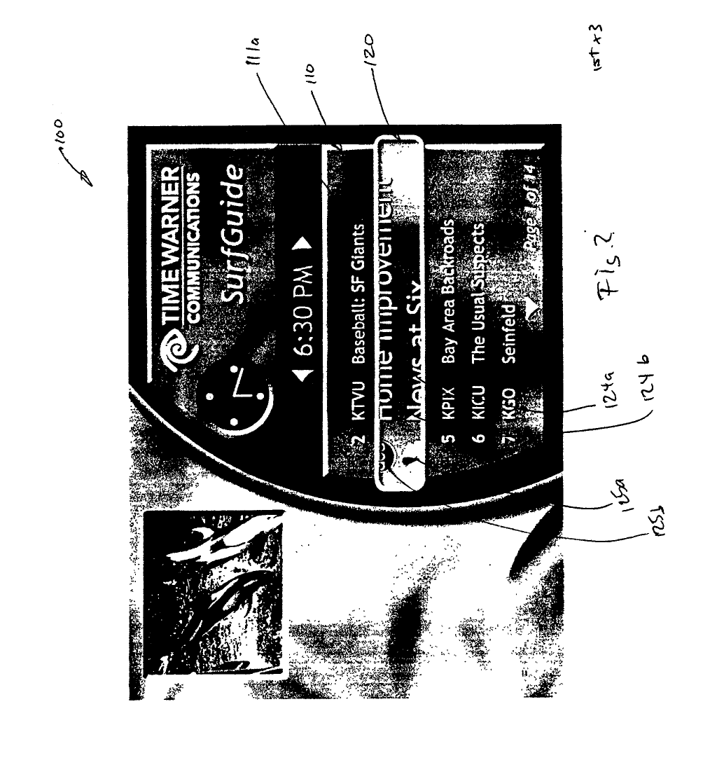

FIG. 2, shows in a perpendicular view of the screen 100, and illustrates how a transition would look when the user scrolls up from channel 4 to channel 3. Area 110 appears to be part of the plane of screen 100, and even though in 3-D perspective it still hovers above the plane. Magnifying area 120 has now moved to a transition view between channel 3, KNTV, and channel 4, KRON.

During this transition, while logo 125a of the NBC network (for purposes of this example only, station KRON is pictured as an NBC affiliate) and text 124a are moving out of the magnifying area 120, logo 125b, the ABC logo of station KNTV (for purposes of this example only, an ABC affiliate) is moving into area 120, along with the text 124b.

Thus, aspects of the present invention disclose an adaptation of content within magnified area 120 to take advantage of the qualities of a magnified view. Whereas, such graphical images as network logos, for example, would be too small and compacted in the original area 110 for clear viewing, and therefore the station call letters are displayed, in the magnifying area 120, the station call letters are dynamically replaced with the logo of the affiliated network or of the station. Also, in magnified area 120 the number of characters in a text description may be slightly reduced, because area 120 may have room for fewer characters than does the original non-magnified screen display. Therefore, what is shown is not just a simple bitmap operation to magnify the digital data on screen, but rather an enhanced presentation focused on the content of the selected information.

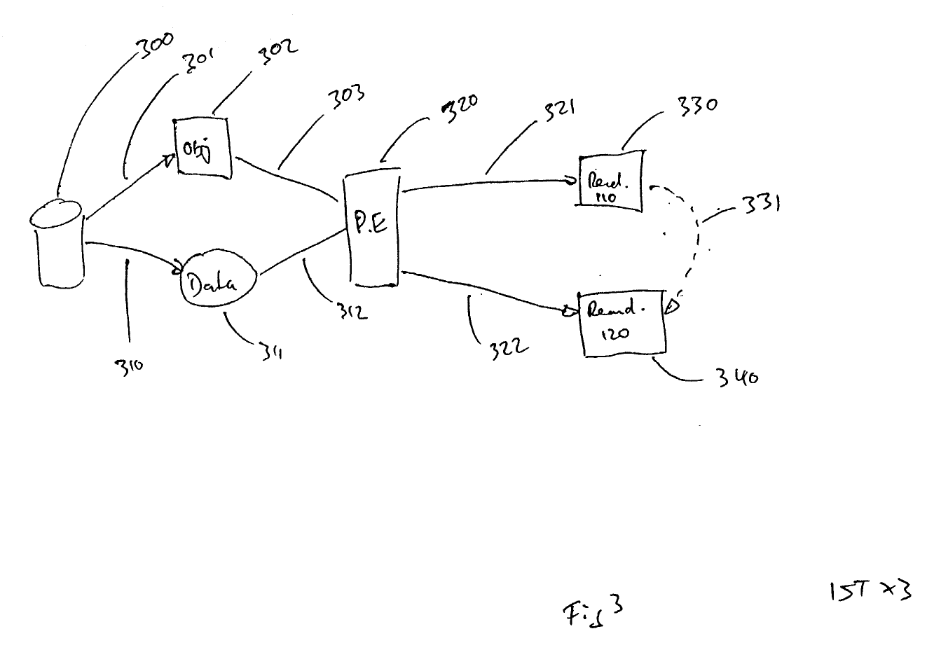

FIG. 3 illustrates how a system for implementing the above-described magnifying technique would operate in accordance with one case. Referring to FIG. 3, out of a main database 300, objects 302 that represent the build of the screen are selected. Data, which is selected by the user viewer in a selection step 310, is then filled in to create an image as seen by a presentation engine 320. Presentation engine 320 then renders a text screen 110 in step 330.

Prior art magnifying programs would have magnified bitmap an image for screen 110 by simply multiplying pixels by a selected magnification factor, as indicated by dotted arrow 331. However, according to some cases, the object selected for magnification is partially or completely recreated by presentation engine 320 as a separate object 120. Thus, the techniques disclosed herein can cause new or different images to appear in the magnified display. This makes the information conveyed within the selected are more clear, evident, and intelligible to the user.

In some cases, some of the selected elements may be displayed unchanged by the magnification from the rendered element 110 into magnified element 120. However, because the preferred the mode is in a 3-D environment, rather than multiplying pixels as is done in the prior art, a 3-D graphical mesh would be stretched and attached to a new object.

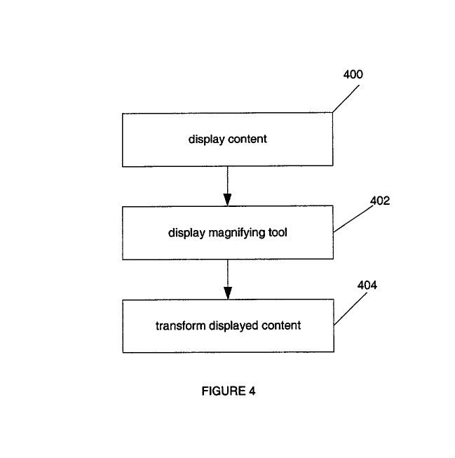

FIG. 4 illustrates a simplified version of such a mesh operation. Area 110 comprises a mesh 410 of a specific granularity. Magnifying area 120 has, in this example, two different mesh sections: section 420 and section 420b, which is inside a subsection 120b. In this example, section 420 is derived from stretching a portion of section 410; whereas section 420b would be regenerated out of the database as a new object. These two different operations are indicated in FIG. 3 as the functions of arrows 331 and 322, respectively.

Other approaches may include bit manipulations and partial regenerations of bitmaps, or even text manipulations and partial regenerations of character maps based on different fonts.

It is to be appreciated that there may be considerable variation in the actual implementation of the techniques described above. FIGS. 4-6 provide examples of how the techniques described above may be implemented. However, it is to be understood that the present invention is not limited to the examples described in FIGS. 4-6.

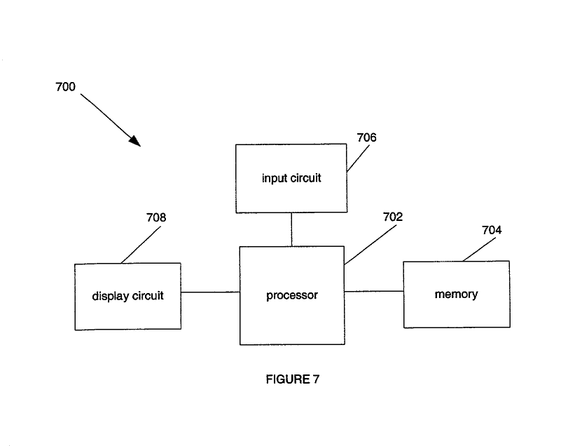

Referring now to FIG. 4, a flow chart of operations performed by an interactive television program guide (IPG) system, such as the system 700 described with reference to FIG. 7 of the drawings is shown. The operations include displaying content on a display screen of the IPG system at block 400. At block 402 a magnifying tool is displayed on the display screen. In one case, the magnifying tool may comprise a display area such as display area 120 described with reference to FIG. 1.

At block 404, the displayed content within the display area is transformed. The transformation includes resizing an object of the displayed content located at coordinates of the display screen within the display area by increasing a size thereof.

The transformation further includes rendering at least a part of the resized object in the display area. This is done by mapping at least one texture to the resized object. The object may be a three-dimensional (3-D) object and the texture may be a data component associated with the object. In one case, the object may correspond to an object 302 described with reference to FIG. 3 of the drawings and the data component may correspond to data 311 shown in FIG. 3 which is mapped or bound by presentation engine 320 to object 302 herein rendering thus an image.

In other cases, the transformation may include substituting an object of the displayed content located at coordinates of the display within the display area with an associated object.

For example, the object may be a text object and the associated object may be a logo associated with the text object. Thus, the logo would be displayed instead of the text object. It is to be understood that the substituted object may include any object that represents a text object in a visually appealing or impressive way and may include modifications such as a color or font changes to the text object.

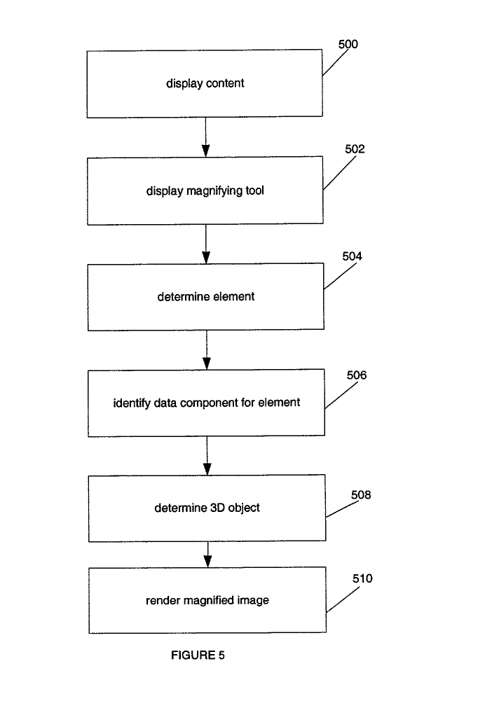

Referring now to FIG. 5 of the drawings, at block 500, the IPG system displays content on a display screen. At block 502, a magnifying tool comprising a display area such as magnifying area 120 referred to in FIG. 1 of the drawings is displayed. At block 504, the IPG system determines an element of the displayed content located at coordinate of the display within the display area. At block 506, the IPG system identifies a data component for the element. At block 508, the IPG system determines a three dimensional object having a surface to which the data component is to be mapped. At block 510, the IPG system renders a magnified image within the display area by mapping the data component to the surface. The element of the displayed content includes a data component and a structural component. Thus, the process illustrated in FIG. 5 of the drawings involves separating the data and structural component of the element, determining a 3-D object having a surface, and mapping the data component to the surface e.g. by texture mapping. The 3-D object may be different from the structural component of the element or it may be the structural component of the element redrawn so that it is larger.

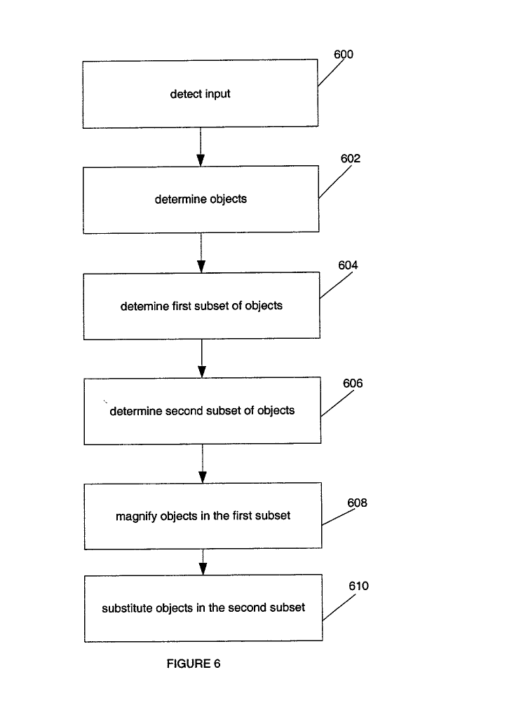

Referring now to FIG. 6 of the drawings, at block 600 the IPG system detects input selecting an area of a display to be magnified. At block 602, the IPG system determines objects located within the selected area. At block 604 the IPG system determines a first subset of the determined objects to magnify. At block 606, the IPG system determines a second subset of the determined objects to substitute.

At block 608, the IPG system magnifies objects in the first subject of objects and at block 610 the IPG system substitutes objects in the second subset of objects. In order to determine which objects to magnify and which objects to substitute, the system identifies predefined object attributes, which specify whether a given object is to be magnified or substituted when selected. The magnification step comprises, in essence, a reversal of the combining of objects 302 to data 311 by presentation engine 320 described in FIG. 3 of the drawings.

Thus, for each object in the first set of objects a structural element and a data element mapped thereto is determined and the magnification includes rendering each object in the first subset by mapping (e.g. texture mapping) the data element to its corresponding structural element which is redrawn to a bigger size.

Referring now to FIG. 7 of the drawings, reference numeral 700 generally indicates an IPG system for performing the magnification techniques described above. It is to be appreciated that the system 700 is highly simplified, with many components omitted, so as not to obscure the present invention. However, one skilled in the art will appreciate that such omitted components necessarily form part of system 700.

System 700 includes a memory 704 which is coupled to a processor 702. The memory stores instructions which when executed by processor 702 cause the processor 702 to perform the magnification techniques described above. Functionally, the system 700 includes an input circuit 706 to detect input relating to various elements within a graphical user interface and a display circuit 708, including a presentation engine in whereby various elements or objects are displayed by a graphical user interface. The design and integration of the various components of system 700 are well known and thus are not further described.

For the purposes of this specification, a computer-readable medium includes any mechanism that provides (i.e. stores and/or transmits) information in a form readable by a machine (e.g. computer) for example, a computer-readable medium includes read-only memory (ROM); random access memory (RAM); magnetic disk storage media; optical storage media; flash memory devices; electrical, optical, acoustical or other form of propagated signals (e.g. carrier waves, infra red signals, digital signals, etc.); etc.

Although the present invention has been described with reference to specific exemplary cases, it will be evident that the various modification and changes can be made to these cases without departing from the broader spirit of the invention as set forth in the claims. Accordingly, the specification and drawings are to be regarded in an illustrative sense rather than in a restrictive sense.

What is claimed is:

1. A method for magnifying content, the method comprising:
displaying content on a display;
displaying a magnifying tool on the display, the magnifying tool comprising a display area; and
transforming the displayed content including resizing an object of the displayed content located at coordinates of the display within the display area by increasing a size thereof, and rendering at least a part of the resized object in the display area including mapping at least one texture to the resized object.

2. The method of claim 1, wherein the texture comprises a data component for the object.

3. The method of claim 1, wherein the displayed content located at coordinates of the display within the display area comprises a further object, the transforming then comprising substituting the further object with an associated object and rendering the associated object in the display area instead of the further object.

4. The method of claim 3, wherein the further object comprises text and the associated object comprises a logo.

5. The method of claim 1, wherein the transforming further comprises modifying a color or a font of the object.

6. The method of claim 1, further comprising detecting input to change a position of the magnifying tool to a new position on the display; and displaying the magnifying tool and transforming the displayed content based on the new position.

7. The method of claim 1, wherein displaying the magnifying tool comprises rendering the magnifying tool to appear in front of the displayed content.

8. A method for magnifying content, method comprising:
(a) displaying content on a display;
(b) displaying a magnifying tool on the display, the magnifying tool comprising a display area;
(c) determining an element of the displayed content located at coordinates of the display within the display area;
(d) identifying a data component for the element;
(e) determining a three-dimensional object having a surface to which the data component is to be mapped; and
(f) rendering a magnified image within the display area by mapping the data component to the surface.

9. The method of claim 8, wherein determining the three-dimensional object comprises identifying a structural component for the element, and increasing a size of structural component.

10. The method of claim 8, wherein the determining three-dimensional object comprises retrieving a predefined three-dimensional object associated with the element.

11. The method of claim 8 further comprising detecting input to change a position of the magnifying tool to a new position on the display.

12. The method of claim 11 further comprising displaying the magnifying tool at the new position; and repeating steps (c)-(f) based on the new position.

13. A method for magnifying content, the method comprising:
detecting input selecting an area of a display;
determining objects located within the selected area;
determining a first subset of the determined objects to magnify;
determining a second subset of the determined objects to substitute;
magnifying objects in the first subset of objects; and
substituting objects in the second subset of objects.

14. The method of claim 13, wherein determining the first and second subset of objects is based on predefined object attributes which specify whether a given object is to be magnified or substituted when selected.

15. The method of claim 13, wherein magnifying the first subset of objects comprising determining a structural element and a data element mapped to the structural element for each object in the subset; and rendering each object in the first subset by mapping the data element to its corresponding structural element redrawn to a bigger size.

16. The method of claim 13, wherein substituting the second subset of objects comprises replacing each object in the second subset with a predefined substitute.

17. The method of claim 16, wherein the each predefined substitute comprises a graphic representation of a text object in the second subset.

18. The method of claim 17, wherein each predefined subset comprises a representation of an object in the second subset in a different font, color, or visual effect.

19. A system comprising a processor and a memory coupled thereto, the memory storing instructions which when executed by the processor cause the processor to perform a method comprising:
displaying content on a display;
displaying a magnifying tool on the display, the magnifying tool comprising a display area; and
transforming the displayed content including resizing an object of the displayed content located at coordinates of the display within the display area by increasing a size thereof, and rendering at least a part of the resized object in the display area including mapping at least one texture to the resized object.

20. The system of claim 19, wherein the texture comprises a data component for the object.

21. The system of claim 19, wherein the displayed content located at coordinates of the display within the display area comprises a further object, the transforming then comprising substituting the further object with an associated object and rendering the associated object in the display area instead of the further object.

22. The system of claim 21, wherein the further object comprises text and the associated object comprises a logo.

23. The system of claim 19, wherein the transforming further comprises modifying a color or font of the object.

24. The system of claim 19, wherein the method further comprising detecting input to change a position of the magnifying tool to a new position on the display; and displaying the magnifying tool and transforming the displayed content based on the new position.

25. The system of claim 19, wherein displaying the magnifying tool comprises rendering the magnifying tool to appear in front of the displayed content.
